(19) United States
(12) Patent Application Publication
(10) Pub. No.: US 2026/0159165 A1
(43) Pub. Date: Jun. 11, 2026

(54) ARRANGEMENT COMPRISING A SUPPORT FOR RECEIVING EQUIPMENT BETWEEN TWO SIDE RAILS OF A VEHICLE

(71) Applicant: FLEXIS, BOULOGNE-BILLANCOURT (FR)

(72) Inventors: Christian DELORD, VILLIERS-SAINT-FREDERIC (FR); Hervé GAUMONT, VILLEBON SUR YVETTE (FR); Nicolas WISS, CHEVREUSE (FR)

(21) Appl. No.: 19/414,749

(22) Filed: Dec. 10, 2025

(30) Foreign Application Priority Data
Dec. 10, 2024 (FR) FR2413802

(51) Int. Cl. B62D 21/03; B60H 1/00; B60R 16/04

(52) U.S. Cl. CPC B62D 21/03; B60H 1/00507; B60R 16/04

(57) ABSTRACT

An arrangement for a vehicle, notably an automobile, includes a left rail and a right rail, at least one left bracket fixed to the left rail and extending transversely toward a median plane of the vehicle, at least one right bracket fixed to the right rail and extending transversely toward the median plane, a support extending transversely between the left rail and the right rail. The support is placed below the left bracket and below the right bracket. The support is configured to support the equipment of the vehicle, fixed above the support and/or below the support.

### INCORPORATION BY REFERENCE TO ANY PRIORITY APPLICATIONS

Any and all applications for which a foreign or domestic priority claim is identified in the Application Data Sheet as filed with the present application are hereby incorporated by reference.

### FIELD

The present disclosure relates to an arrangement for a vehicle comprising a left rail and a right rail, at least one left bracket fixed to the left rail and at least one right bracket fixed to the right rail, and a support extending transversely between the left rail and the right rail. The present disclosure also relates to a method for obtaining such an arrangement. The present disclosure further relates to a chassis comprising such an arrangement. The present disclosure also relates to a vehicle comprising such a chassis or such an arrangement.

### BACKGROUND

A vehicle, in particular an automobile, generally comprises a cramped engine compartment. This results in a lack of space to house the increasingly numerous pieces of equipment of such a vehicle. This issue is even more pronounced for a vehicle comprising a compartment arranged at the front and a short front overhang.

The objective of the present disclosure is to overcome the above disadvantages. Furthermore, the present disclosure allows to support multiple pieces of equipment within an engine compartment while complying with crash regulations, limiting mass, and finally in being particularly economical.

### SUMMARY

To achieve this objective, the present disclosure relates to an arrangement for a vehicle, notably an automobile, comprising a left rail and a right rail, notably arranged at the front of such a vehicle, at least one left bracket fixed to the left rail and extending transversely toward a median plane of such a vehicle, at least one right bracket fixed to the right rail and extending transversely toward the median plane, a support extending transversely between the left rail and the right rail, the support being placed below the at least one left bracket and below the at least one right bracket. The support is intended to support equipment of such a vehicle, such equipment being fixed above the support and/or below the support.

According to advantageous but non-mandatory aspects of the present disclosure, such an arrangement may comprise one or more of the following features taken according to any technically permissible combination:

The support comprises at least one threading or at least one nut fixed to the support on each side according to the transverse direction, the at least one left bracket and the at least one right bracket each comprising at least one hole, the arrangement comprising at least one screw passing through the at least one hole of the at least one left bracket and at least one screw passing through the at least one hole of the at least one right bracket so as to cooperate with the at least one threading or the at least one nut fixed to the support so as to ensure the fixing of the support relative to the at least one left bracket and relative to the at least one right bracket.

The arrangement comprises a first left bracket and a second left bracket fixed to the left rail, the first and second left brackets being arranged one behind the other according to the longitudinal direction while being distanced from each other, and a first right bracket and a second right bracket fixed to the right rail, the first and second right brackets being arranged one behind the other according to the longitudinal direction while being distanced from each other.

The support is a folded and/or stamped sheet.

The support has a section according to a vertical and longitudinal plane in the shape of an inverted Omega.

The support comprises holes in a vertical axis and nuts with axes common or substantially common to the axes of the holes, the nuts being fixed below the support, notably by welding, for the fixing of equipment coming above the support, and/or the support comprises screws in a vertical axis passing through the support and extending below the support, the screws being fixed to the support, notably by welding, for the fixing of equipment coming below the support.

The arrangement comprises a battery fixed above the support, notably a 12 Volt lead-acid service battery, and/or an air conditioning compressor fixed above the support, and/or a solenoid valve fixed below the support, and/or an element of a vehicle passenger compartment air conditioning system, the element being fixed below the support, and/or a heating element for a passenger compartment heating system of such a vehicle, the heating element being fixed below the support.

According to a second aspect, the present disclosure relates to a method of assembling an arrangement such as mentioned above, this method comprising a step of providing a body comprising a left rail and a right rail, at least one left bracket being fixed to the left rail and at least one right bracket being fixed to the right rail, a support for the fixing of equipment, followed by a step of docking the body with the support via a vertical translation from top to bottom of the body so that the at least one left bracket and the at least one right bracket come above the support.

According to a third aspect, the present disclosure relates to a vehicle chassis, notably an automobile chassis, characterized in that it comprises an arrangement as mentioned above.

According to a fourth aspect, the present disclosure relates to a vehicle, notably an automobile, comprising a chassis such as described above, or an arrangement as described above.

### BRIEF DESCRIPTION OF THE DRAWINGS

These objects, features, and advantages of the present disclosure will be detailed in the following description of the embodiment including but not limiting in relation to the attached figures among which:

FIG. 1 is a schematic view of a vehicle according to one embodiment.

FIG. 2 is a partial perspective view of a chassis of the vehicle according to one embodiment.

FIG. 3 is a detailed perspective view of the chassis according to the embodiment.

FIG. 4 is a partial perspective view of an arrangement according to the embodiment.

FIG. 5 is another partial perspective view of the arrangement according to the embodiment.

FIG. 6 is a perspective view of a support of the arrangement according to the embodiment.

FIG. 7 is another perspective view of the support of the arrangement according to the embodiment.

FIG. 8 is a partial schematic sectional view according to a vertical and longitudinal plane of the arrangement according to the embodiment.

FIG. 9 is a detailed sectional view in a vertical and longitudinal plane of the arrangement according to the embodiment.

### DETAILED DESCRIPTION

The direction according to which a vehicle, notably an automobile, displaces in a straight line is defined as being the longitudinal direction X. By convention, the direction perpendicular to the longitudinal direction, located in a plane parallel to the ground, is called the transverse direction Y. The third direction, perpendicular to the other two, is called the vertical direction Z. Thus, a direct XYZ reference frame is used in which X is the longitudinal direction in the front-rear direction of the vehicle, therefore directed toward the rear, Y is the transverse direction directed toward the right, and Z is the vertical direction directed upward. The forward direction corresponds to the direction in which the vehicle usually displaces in the longitudinal direction and is opposite to the rear direction.

As schematically illustrated in FIG. 1 a vehicle 1, preferably an automobile, comprises a cramped compartment 7. Preferably, the compartment 7 is arranged at the front of the vehicle 1. The vehicle 1 has a short front overhang, meaning that the distance D between the axis of a front wheel 8 of the vehicle 1 and a front end of the vehicle 1 is between 60 and 90 cm, for example equal to 75 cm.

Preferably, the vehicle 1 comprises a powertrain 9, for example electric, arranged at the rear. In this case, advantageously, the vehicle 1 comprises a means of torque transmission to the rear wheels, meaning that the vehicle 1 is propelled in displacement by propulsion.

The vehicle 1 comprises a chassis 6. The vehicle 1, or the chassis 6, comprises an arrangement 2 as will be seen later.

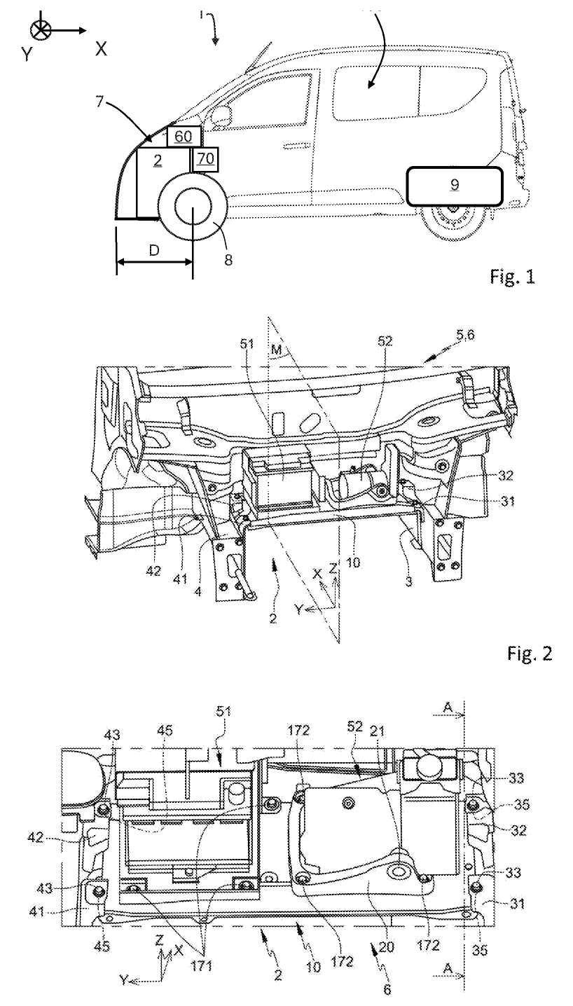

As illustrated in FIG. 2, the arrangement 2 comprises a left rail 3 and a right rail 4. Preferably, the left and right rails are arranged at the front of the vehicle 1, in other words, they are front rails. Alternatively, the rails are arranged at the rear of the vehicle, in other words, they are rear rails (embodiment not illustrated).

As illustrated in FIG. 3, the arrangement 2 further comprises at least one left bracket 31; 32 fixed to the left rail 3 and extending transversely toward a median plane M of the vehicle 1 (illustrated in FIG. 2). The median plane M extends vertically and longitudinally, in the middle, or substantially in the middle of the vehicle 1 according to the transverse direction.

The arrangement 2 further comprises at least one right bracket 41; 42 fixed to the right rail 4 and extending transversely toward the median plane M of the vehicle 1.

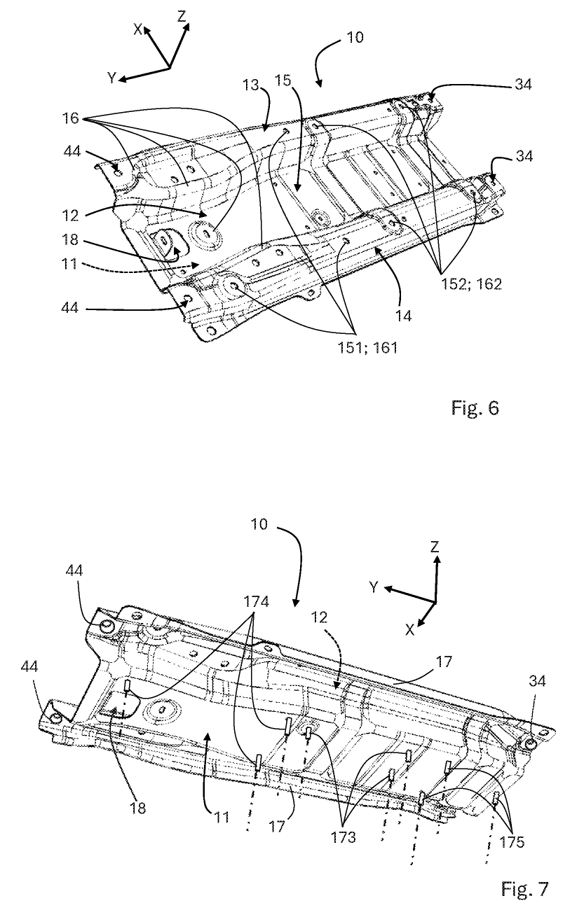

The arrangement 2 further comprises a support 10 extending transversely between the left rail 3 and the right rail 4. As illustrated in FIGS. 6, 7, and 8, the support 10 comprises a lower face 11, facing the ground or substantially facing the ground in the mounted position of the support 10. The lower face 11 is therefore oriented downward or substantially oriented downward. The support 10 comprises an upper face 12, opposite the lower face 11, in other words, oriented upward, or substantially oriented upward.

In the illustrated embodiment, particularly in FIG. 3, the arrangement 2 comprises a first left bracket 31 and a second left bracket 32 fixed to the left rail 3. The first and second left brackets 31, 32 are then arranged one behind the other according to the longitudinal direction while being distanced from each other. The arrangement 2 further comprises a first right bracket 41 and a second right bracket 42 fixed to the right rail 4. The first and second right brackets 41, 42 are then arranged one behind the other according to the longitudinal direction while being distanced from each other.

Preferably, the first and second left brackets 31, 32 are fixed to the left rail 3 by welding, and the first and second right brackets 41, 42 are fixed to the right rail 4 by welding.

More precisely, the support 10 is placed below the left brackets 31; 32 and below the right brackets 41; 42. In other words, the support 10 is arranged under the first and second left brackets and under the first and second right brackets.

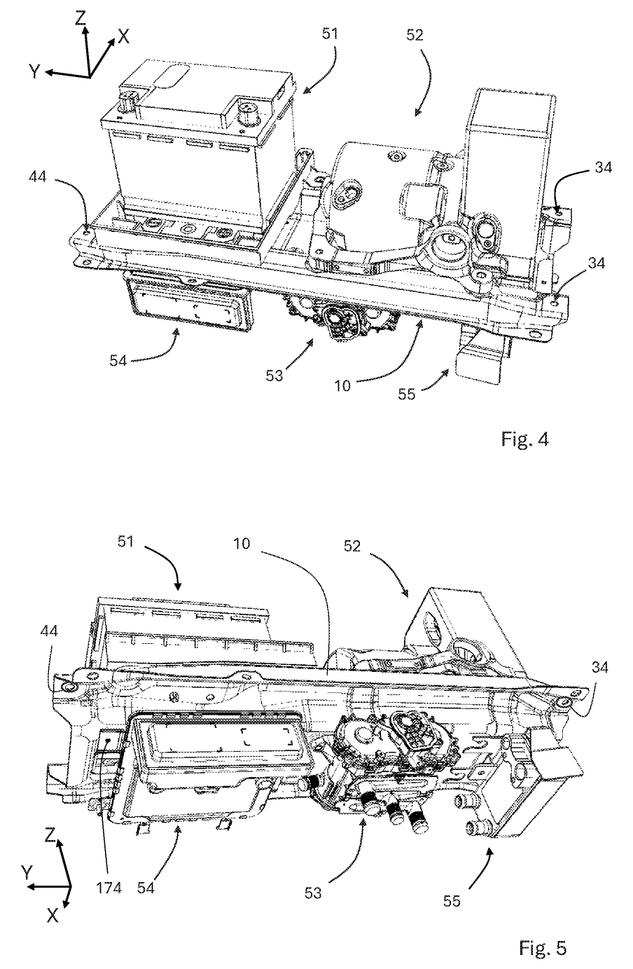

The support 10 is intended to support the equipment 51; 52; 53; 54; 55 of the vehicle 1. The equipment is fixed above the support 10, or the equipment is fixed below the support 10. Advantageously, as illustrated, in particular, in FIGS. 4 and 5, some equipment is fixed under the support 10, and other equipment is fixed on the support 10.

As illustrated in FIG. 7, the support 10 preferably comprises at least one threading or at least one nut 34; 44, fixed to the support 10 on each side according to the transverse direction. Preferably, these are additional nuts, fixed on the lower face 11 of the support 10, in other words, under the support 10. Advantageously, in the case of nuts, these nuts 34, 44 are welded to the support 10 so as to facilitate the cooperation of screws in these nuts. These nuts 34, 44 are intended to participate in the fixing of the support 10 relative to the respective brackets 31, 32, 41, 42.

Thus, to ensure the fixing of the support 10, the first and second left brackets 31, 32 and the first and second right brackets 41, 42 each comprise at least one respective hole 35, 45 referenced in dotted lines in FIG. 3.

As illustrated in FIG. 3, the arrangement 2 further comprises screws 33. Preferably, a screw 33 passes through a hole 35 provided in the first left bracket 31 and cooperates with a nut 34 fixed under the support 10. Preferably, a screw 33 passes through a hole 35 provided in the second left bracket 32 and cooperates with a nut 34 fixed under the support 10. Preferably, a screw 43 passes through a hole 45 provided in the first right bracket 41 and cooperates with a nut 44 fixed under the support 10. Preferably, a screw 43 passes through a hole 45 provided in the second right bracket 42 and cooperates with a nut 44 fixed under the support 10.

In the illustrated embodiment, a single screw 33, 43 thus ensures the fixing of the support 10 relative to a single bracket 31, 32, 41, 42.

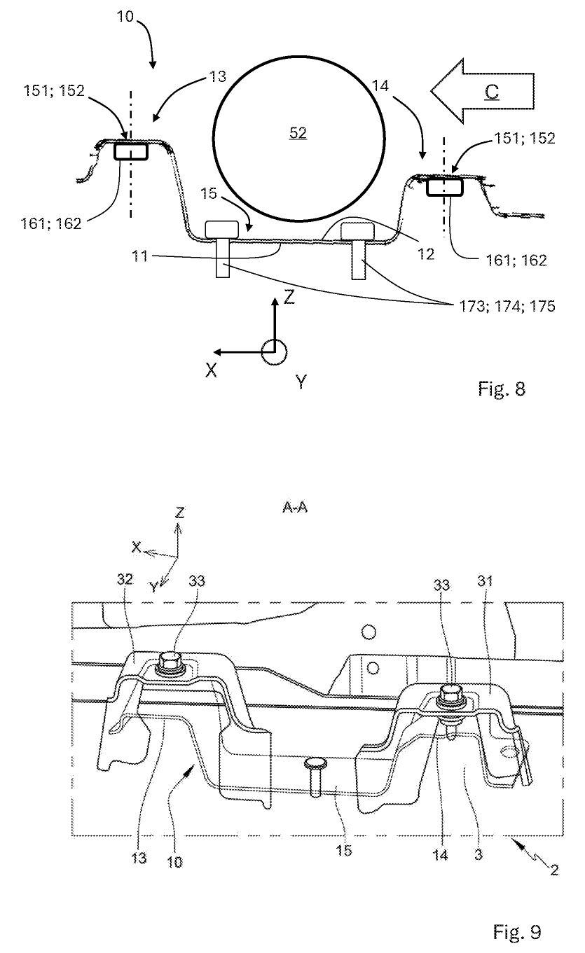

Advantageously, the support 10 is a folded and/or stamped sheet, for example, in steel. The thickness of the sheet used for obtaining the support 10 is, for example, between 1 mm and 2 mm, or even between 1.5 mm and 1.75 mm. As illustrated, in particular, in FIG. 8, the support 10 has a section according to a vertical and longitudinal plane in a general, overall shape of an inverted Omega, in other words, upside down. Indeed, as illustrated in FIGS. 6, 8, and 9, the support 10 comprises substantially two U-shaped beams 13,14 extending transversely, oriented downward, and connected to each other by a flat or substantially flat porting 15 extending substantially in a transverses and longitudinal plane.

Advantageously, folds and/or curved and/or bosses and/or stampings 16 are provided at each "beam" 13, 14 and at the flat portion 15. Optionally, as illustrated in FIG. 7, the support 10 comprises dropped edges 17, at least over part of the length of the support extending according to the transverse direction.

As illustrated in FIG. 6, the support 10 comprises holes 151, 152 in a vertical axis. The support 10 further comprises nuts 161, 162 with axes common or substantially common to the axes of the holes 151, 152. The nuts 161, 162 are then fixed below the support 10, in other words, against the lower face 11, for example by welding. The holes 151, 152 opening out at the respective nuts 161, 162 allow for the fixing of the equipment 51, 52 arranged on the support, in other words, above it. For this purpose, as illustrated in FIG. 3, the screws 171 sandwich the equipment 51 between the heads of the screws 171 and the support 10 via the cooperation of the screws 171 with the nuts 161. For example, two screws 171, or three, or even four, are provided to cooperate with the same number of nuts 161. Similarly, the screws 172 sandwich the equipment 52 between the head of the screws 172 and the support 10 via the cooperation of the screws 172 with the nuts 162. For example, two screws 172, or three, or even four, are provided to cooperate with the same number of nuts 162.

The arrangement 2 preferably comprises equipment 51, 52, 53, 54, 55. For example, equipment 51 is a battery fixed here above the support 10. The battery 51 is advantageously a service battery, for example, lead-acid, preferably having a voltage at its terminals of about 12 Volts. Alternatively, it may be another battery technology. For example, the equipment 52 is a compressor of an air conditioning system 60 equipping the vehicle 1. The equipment 52 is fixed above the support 10.

Preferably still, as illustrated in FIG. 7, the support 10 comprises screws 173 in a vertical axis passing through the support 10 and extending under the support 10. Preferably still, as illustrated in FIG. 7, the support 10 comprises screws 174 in a vertical axis passing through the support 10 and extending under the support 10. Preferably still, as illustrated in FIG. 7, the support 10 comprises screws 175 in a vertical axis passing through the support 10 and extending under the support 10. The screws 173, 174, 175 are advantageously fixed to the support 10, for example by welding. For this purpose, holes are, for example, previously provided in the support, and the screws 173, 174, 175 are inserted into these holes before being welded so as to be immobilized. Thus, the screws 173, 174, and 175 play the role of a stud or equivalent for the fixing of equipment arranged below the support 10. The nuts then cooperate with the screws 173, 174, 175 to ensure the respective fixing of the equipment 53, 54, and 55. For example, three screws 173 are provided and as many nuts for the fixation of the equipment 53. For example, three screws 174 are provided and as many nuts for the fixing of the equipment 54. For example, three screws 175 are provided and as many nuts for the fixing of the equipment 55. Fewer or more screws, and the same number of corresponding nuts, may also be suitable.

Preferably, the equipment 53 is a solenoid valve, for example, with seven ports, and it is fixed below the support 10. Preferably, the equipment 55 is an element of the air conditioning system 60. The equipment 55 is fixed below the support 10. Preferably, the equipment 54 is a heater for a heating system 70 for a passenger compartment 100 of the vehicle 1. The equipment 54 is fixed below the support 10.

For example, the length of the support 10 according to the transverse direction is 754 mm, the width of the support 10 according to the longitudinal direction is 274 mm, and the height of the support 10 is 60 mm.

One embodiment of an assembly or mounting method of the arrangement 2 will now be described. Initially, a body 5 comprising the left rail 3 and the right rail 4 is provided. At least one left bracket, preferably the first left bracket 31 and the second left bracket 32, is already fixed to the left rail 3. At least one right bracket, preferably the first right bracket 41 and the second right bracket 42, is already fixed to the right rail 4. The support 10 for the fixing of the equipment 51, 52, 53, 54, 55 is also provided. Possibly, all equipment, or only some equipment, is pre-fixed on the support 10 and/or under the support.

Then, a step of docking the body 5 with the support 10 is carried out. To do this, the body 5 is vertically translated from top to bottom so that the left brackets 31, 32 and the right brackets 41, 42 come just above the support 10. In other words, the support 10 is positioned, placed in such a way that the brackets 31, 32, 41, 42 of the body can come precisely into contact with the support 10, above the two transverse ends of the support 10. Then, it remains only to proceed with a step of screwing the screws 33 to make them cooperate with the nuts 34 of the support 10 on the left side (see FIG. 9) and a step of screwing the screws 43 to make them cooperate with the nuts 44 of the support 10 on the right side. Note that this screwing is particularly easy since it is done from above and the support is preferably securely held in position. The screws are therefore inserted into the corresponding nuts from above, which also allows for excellent visibility for this assembly step. After screwing, the assembly of the support, possibly pre-equipped with some or all of the equipment 51, 52, 53, 54, 55, with the body 5 is obtained.

Possibly, some equipment or even all the equipment is fixed after the fixing of the "bare" support with the body 5.

In summary, the solution relates to a multifunction support 10 optimized in terms of cost and mass, while being compatible with impact constraints related in particular to a relatively short overhang D (see FIG. 1), for example, about 75 cm.

Thus, the arrangement 2 extends little according to the longitudinal direction X toward the front. This particularity is obtained notably by optimizing the locations of the equipment, namely in a sandwich on either side of the support 10, in other words, above and below. Furthermore, the equipment is preferably arranged with their largest dimension extending in the transverse direction so as to limit the footprint according to the longitudinal direction as well as according to the vertical direction. This may result in space under the support, even though it supports equipment 53, 54, 55 below. In other words, the equipped support occupies one level, and another level or floor remains available below.

Thus, the architecture and placement of the elements are compatible with the short overhang of the vehicle.

The solution thus allows to avoid designing, manufacturing, and mounting a specific support for each piece of equipment. Significant savings in design time, testing, stock management (one support reference instead of five references), and manufacturing time are thus achieved. Furthermore, the solution consumes less material, making it more economical and, a fortiori, lighter. In the illustrated embodiment, five pieces of equipment are received, maintained, and positioned relative to the single support 10. The vehicle thus equipped sees its mass optimized, which improves its range, which is particularly sought after in the case of an electric vehicle.

As a reminder, the shape of the support with an Omega section, accordion-like, allows to facilitate and optimize the placement of components or equipment. Notably, the equipment 52, preferably an electric air conditioning compressor powered by high voltage, for example, about 800 V, without a belt, is partly housed in the hollow of the Omega, between the two U-beams 13, 14 of the support 10 as illustrated in FIG. 8. Preferably, it is the lower part of the compressor 52 that is housed in the hollow between the two U-beams forming part of the support 10. Advantageously, the arrangement 2 comprises a base 20, an intermediate support, between the support 10 and the compressor 52. The base 20 or the compressor 52 then comprises a filtration means 21 arranged between the base and the compressor to not transmit vibrations from the compressor to the support, and consequently to the body 5 of the vehicle. For example, this base 20 is in aluminum alloy, preferably obtained by casting. Thus, the compressor 52 is arranged at the front of the vehicle, even in the case of a rear-arranged engine, the air conditioning system 60 being preferably also arranged at the front of the vehicle.

Furthermore, the shape of the support 10 offers better resistance according to the vertical direction, which allows to reduce the thickness of the sheet used for obtaining the support. As seen previously, this results in material savings, therefore a cost saving on the material and a mass saving. As previously mentioned, folds and/or curves and/or bosses and/or stampings 16 and/or dropped edges 17 are preferably provided. These shapes 16, 17 stiffen the support 10 without significant addition of material or surplus mass.

Preferably, as illustrated in FIGS. 6 and 7, an orifice or hole 18 is provided within the substantially flat portion 15 of the support 10 at the reception area of equipment 51. Indeed, preferably, the equipment 51 is the 12 V battery, for example, lead-acid, called service battery, which is generally equipped with a hose or pipe for evacuating the acid of such a battery. Thus, the hose is inserted into the hole 18 so that it passes through the support 10 and can extend to the bottom of the vehicle to avoid any contact between the acidic substances that would evacuate and the chassis or a component of the vehicle.

The shape of the support 10 also offers an advantage in terms of behavior in the event of an impact or frontal impact C schematically illustrated in FIG. 8. Indeed, the support 10 compresses, folds, at its flat portion 15 between the two beam-type portions 13, 14 during a front impact. Thus, the support 10 does not interfere with the damping role conferred by the rails. Note that the mode of fixing of the support on the rails contributes to not interfering with the role of the rails in the event of an impact. Indeed, the two left brackets 31, 32, independent of each other and distanced from each other in the longitudinal direction, and the two right brackets 41, 42, independent of each other and distanced from each other according to the longitudinal direction, have little impact in terms of stiffening the support. Thus, the flat or substantially flat portion 15 of the support can fold easily thanks to these four point type and spaced fixings 31, 32, 41, 42 with the body 5. Preferably, these four brackets are fusible, they break, or their welds on the rail give way in the event of an impact, in particular the two brackets 31, 41 located at the front of the vehicle. In other words, the support 10 does not interfere, does not limit, the compression of the rails 3, 4 during an impact. For example, the center distance between the two screws 33, respectively the two screws 43, for the fixing of the support, according to the longitudinal direction, is within a range from 150 to 200 mm, notably about 190 mm. The flat portion 15 between the two left or right fixing points extends according to the longitudinal direction between 80 mm and 130 mm so as to allow easy folding in the event of an impact.

Preferably, the element or the equipment 54 is preferably known under the abbreviation HVCH for the Anglo-Saxon term High Voltage Central Heating. It is an element allowing the heating of the cooling/heating system liquid equipping the vehicle, for example, by comprising a heating resistor.

Preferably, the element or the equipment 55 is known as a "Chiller" and is part of the vehicle air conditioning system 60. It allows for heat exchange between a liquid and a gas used in the air conditioning system, and vice versa. The equipment 55 is preferably connected by two gas pipes (inlet/outlet) and two liquid pipes (inlet/outlet). Thus, the equipment 55 allows for the transfer of heat from the liquid to the air conditioning gas or cold from the gas to the liquid.

Preferably, the equipment 53 is a solenoid valve with seven ports, for example, being part of the cooling system. It is able to distribute a coolant to different components depending on the desired cooling modes, for example, cooling a battery, the passenger compartment 100, or an electric motor of the EPT (from the English "Electric Power Train") or only the passenger compartment.

As previously mentioned, the fixing of the equipment 51, 52 coming onto the support 10 is facilitated since the nuts 161, 162, preferably welded under the support, are arranged at the lower face 11. Thus, it is sufficient to insert screws 171, 172 from above, pass through the holes provided in each component (or its base if applicable) and cooperate with the nuts 161, 162. The fixing of the equipment 53, 54, 55 coming under the support is facilitated since the screws or studs 173, 174, 175, preferably welded to the support 10, extend substantially vertically under the support 10. Thus, it is sufficient to place, for example, one by one, each piece of equipment 53, 54, 55 via holes provided in these elements so that the threaded rods of the screws or studs 173, 174, 175 protrude. Then, it is sufficient to cooperate the nuts with these screws to ensure the maintenance of each element relative to the support. Note that these screws 173, 174, 175 participate in the pre-maintenance of the respective pieces of equipment 53, 54, 55 before tightening the nuts.

Obviously, other equipment, instead of those mentioned, or in addition to those mentioned, or less equipment can be fixed on or under the support 10. Possibly, the equipment fixed on the support in the illustrated embodiment can be fixed under the support and/or vice versa. In this case, possibly, the support has a different shape, or even is mounted upside down, head down.

In summary, the solution makes it possible to fix several pieces of equipment, for example, five, by means of a single support 10 extending transversely within an engine compartment 7 arranged at the front. As mentioned, the solution allows to reduce the overall mass of the vehicle by providing only one support and not one per piece of equipment to be fixed. This results in a reduction in the number of fixing systems, notably screws and/or nuts. Notably, only two screws 33 and two screws 43 are sufficient to fix the single support 10 to the body 5. Obviously, the solution reduces the number of supports since only one is sufficient.

Furthermore, on an electric vehicle equipped with an electric motor, arranged at the rear preferably of the propulsion type, it becomes easy to arrange a motor at the front, preferably an electric motor under the support and consequently under the equipment 53, 54, 55 if applicable. Indeed, the solution that allows to arrange and concentrate around the support 10 the equipment, offers available space below. In other words, the solution facilitates the transition from a propulsion vehicle with a rear motor to a four-wheel-drive vehicle, equipped with a front traction means, particularly when it is a relatively compact electric motor.

Thus, although the engine compartment 7 is cramped, particularly when the front overhang is short, and many bulky pieces of equipment need to be arranged inside, the solution is space-saving. Furthermore, the solution allows to support multiple pieces of equipment on a single support within the engine compartment, while complying with impact regulations, limiting mass, and finally being particularly economical.

Although the illustrated embodiment corresponds to a front engine compartment, the solution could be adapted to a rear engine compartment.

In conclusion, the solution therefore achieves the sought objective of housing equipment within an engine compartment with a short overhang without affecting performance in terms of rail deformation in the event of a crash and presents the advantage of being usable for other vehicles, for example, with a more significant front overhang, or even on other vehicles with a cramped engine compartment.

What is claimed is:

1. An arrangement for a vehicle comprising:
a left rail and a right rail configured to be arranged at the front of the vehicle;
at least one left bracket fixed to the left rail and configured to extend transversely toward a median plane of the vehicle;
at least one right bracket fixed to the right rail and configured to extend transversely toward the median plane; and
a support extending transversely between the left rail and the right rail,
wherein the support is placed below the at least one left bracket and below the at least one right bracket, and
wherein the support is configured to support an equipment of the vehicle, the equipment is fixed above the support and/or below the support.

2. The arrangement according to claim 1, wherein the support comprises at least one threading or at least one nut fixed to the support on each side according to a transverse direction, the at least one left bracket and the at least one right bracket each comprising at least one hole, the arrangement comprising at least one screw passing through the at least one hole of the at least one left bracket and at least one screw passing through the at least one hole of the at least one right bracket so as to cooperate with the at least one threading or the at least one nut fixed to the support for fixing of the support relative to the at least one left bracket and relative to the at least one right bracket.

3. The arrangement according to claim 1, wherein the arrangement further comprises:
a first left bracket and a second left bracket fixed to the left rail, the first and second left brackets being arranged one behind the other according to a longitudinal direction while being distanced from each other; and
a first right bracket and a second right bracket fixed to the right rail, the first and second right brackets being arranged one behind the other according to the longitudinal direction while being distanced from each other.

4. The arrangement according to claim 1, wherein the support is a folded and/or stamped sheet.

5. The arrangement according to claim 1, wherein the support has a section according to a vertical and longitudinal plane in a shape of an inverted Omega.

6. The arrangement according to claim 1, wherein the support comprises holes with a vertical axis and nuts with axes common or substantially common to the axes of the holes, the nuts being fixed below the support, for the fixing of the equipment coming above the support.

7. The arrangement according to claim 1, wherein the support comprises screws with a vertical axis passing through the support and extending under the support, the screws being fixed to the support, for fixing of the equipment coming below the support.

8. The arrangement according to claim 1, wherein the arrangement comprises at least one of:
a battery fixed above the support;
an air conditioning compressor fixed above the support;
a solenoid valve fixed below the support;
an element of an air conditioning system, of a passenger compartment of the vehicle, the element being fixed below the support; or
a heating element for a heating system, of a passenger compartment of the vehicle, the heating element being fixed below the support.

9. An assembly method of the arrangement according to claim 1, comprising providing:
a body comprising a left rail and a right rail, at least one left bracket being fixed to the left rail and at least one right bracket being fixed to the right rail; and
a support for the fixing of the equipment, followed by docking the body with the support via a vertical translation from top to bottom of the body so that the at least one left bracket and the at least one right bracket come above the support.

10. A vehicle chassis, comprising the arrangement according to claim 1.

11. A vehicle, comprising the arrangement according to claim 1.
